(19) United States
(12) Patent Application Publication
(10) Pub. No.: US 2004/0244724 A1
(43) Pub. Date: Dec. 9, 2004

(54) Step device and system for domestic pets

(76) Inventor: Deborah Runge, Jupiter, FL (US)

Correspondence Address: David P. Lhota, Stearns Weaver Miller, et al., Suite 1900, 200 East Broward Boulevard, Fort Lauderdale, FL, 33301, US

(21) Appl. No.: 10/836,496

(22) Filed: Apr. 30, 2004

Related U.S. Application Data
(60) Provisional application No. 60/466,822, filed on Apr. 30, 2003.

(51) Int. Cl. A01K 29/00

(52) U.S. Cl. 119/847

(57) ABSTRACT

A pet step device comprising a lightweight, portable, foam-based stair that may be positioned next to a vehicle, bed, couch or other piece of elevated place for enabling a pet to easily and safely reach and navigate the elevated location, wherein the pet step device comprises a plurality of elevated platforms or steps made in sections from polyurethane foam that are stacked and bonded together. The cover preferably comprises a soft, pile-height, low-impact fabric cover, but may comprise a waterproof material having rubber pads on the bottom of the device and on the steps to prevent slipping.

### CROSS REFERENCE TO RELATED APPLICATIONS

This application claims the benefit of provisional patent application Ser. No. 60/466,822 filed Apr. 30, 2003.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to steps, and more particularly, to a lightweight, foam-based, composite step device and system for use by domestic pets in reaching and leaving elevated places, such as beds and couches.

2. Description of the Background Art

It is known that domestic pets, such as cats and dogs, like to and sometimes need to access elevated places, including beds, couches and automobiles. Pets typically jump or navigate across progressively higher furniture to reach desired heights. For some pets, especially older and physically impaired pets such as those with joint problems, hip dysphasia and arthritis, jumping to and off elevated spots can expose the pet to back, neck or leg injuries and can aggravate existing injuries. While certain step devices exist in the prior art, they tend to be heavy and complicated in construction and offer no alternative design options. For instance, U.S. Pat. No. 5,794,391, issued to Howard, discloses a lightweight, highly portable, yet strong, fiberglass step unit. U.S. Pat. No. 5,794,570, issued to Foster, discloses a set of steps for use with a pet-grooming tub. Design U.S. Pat. No. 383,261, issued to Karsten, discloses a two-step design for pets. Design U.S. Pat. No. 429,038, issued to Forester, discloses a pet step stool.

The foregoing patents fail to adequately address and solve the problems noted in the prior art as contemplated by the instant invention. Consequently, there exists a need for a step device that can be easily transported, decorated and used to reduce stress on a pet's bones and joints. If a step device existed that was portable, lightweight, durable and adapted for different looks and adapted for safe use by pets in reaching elevated places, it would be well received. The instant invention addresses this unfulfilled need in the prior art.

### BRIEF SUMMARY OF THE INVENTION

Based on the foregoing, it is a primary object of the instant invention to provide a pet step device for safe use by domestic pets in reaching elevated places.

It is another object of the instant invention to provide a pet step device that reduces the stress and impact on an animal's legs, back and joints.

It is yet another object of the instant invention to provide a pet step device that may comprise three, four, five, six or more steps.

It is also object of the instant invention to provide a pet step device that may be used by pets for exercise and rehabilitation.

It is an additional object of the instant invention to provide a pet step device having interchangeable design covers.

It is a further object of the instant invention to provide a pet step device that is skid resistant.

It is another object of the instant invention to provide a pet step device that repels water.

In light of the foregoing, the instant invention teaches a pet step device comprising a lightweight, portable, foam-based stair that may be positioned next to a vehicle, bed, couch or other piece of elevated place for enabling a pet to easily and safely reach and navigate the elevated location. The pet step device comprises a plurality of elevated platforms or steps, sides, backside, bottom side and at least one removable cover. The steps are preferably made from polyurethane foam and individually fabricated and bonded together to achieve maximum support and weight distribution. The instant invention may comprise three, four, five or six steps, which may comprise a plurality of different sizes for accessing various heights and depth for accommodating larger pets. The cover preferably comprises a soft, pile-height, low-impact fabric cover, such as shearling fabric. The instant invention is designed so that pets can avoid back, neck and leg injuries that can occur when pets jump to and from high places and to accommodate pets with existing conditions. The pet step device preferably comprises a soft, yet durable design and offers an alternative to jumping to help reduce stress and strain on the pet's bones and joints. The pet step device may also be used for exercise or rehabilitation. For instance, two step devices may be placed back-to-back to facilitation climbing up one side and down the other side. The pet step device may include a skid resistant adhesive back or bottom and skid resistant strips on the steps or provided for placement on the steps by the owner.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of the preferred embodiment of the pet step device in accordance with the instant invention.

FIG. 2 is a side cross-sectional view of the preferred embodiment of the pet step device in accordance with the instant invention illustrating the invention with three steps.

FIG. 3 is a side cross-sectional view of the preferred embodiment of the pet step device in accordance with the instant invention illustrating the invention with four steps.

FIG. 4 is a side cross-sectional view of the preferred embodiment of the pet step device in accordance with the instant invention illustrating the invention with five steps.

FIG. 5 is a bottom elevational view of the preferred embodiment of the pet step device in accordance with the instant invention.

FIG. 6 is a bottom elevational view of an alternative embodiment of the pet step device having a cover that encloses the entire step structure and has a fastener for opening and closing in accordance with the instant invention.

FIG. 7 is a specification chart for the preferred fabric cover in accordance with the instant invention.

FIG. 8 is a specification chart for the preferred rubber material used for the rubber pads on the steps and bottom to prevent slippage in accordance with the instant invention.

### DETAILED DESCRIPTION OF THE INVENTION

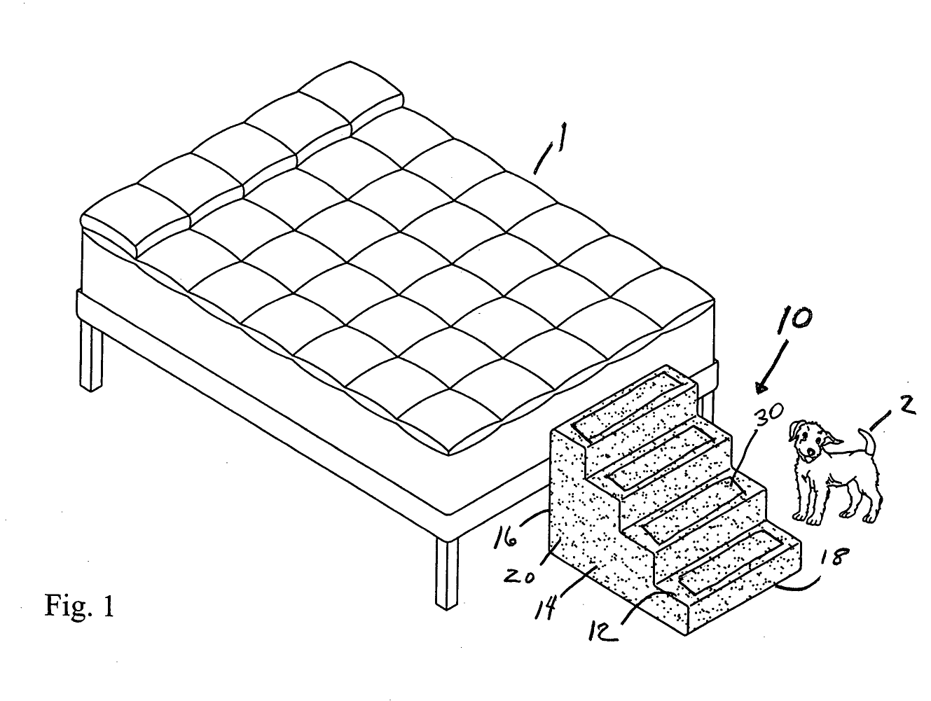

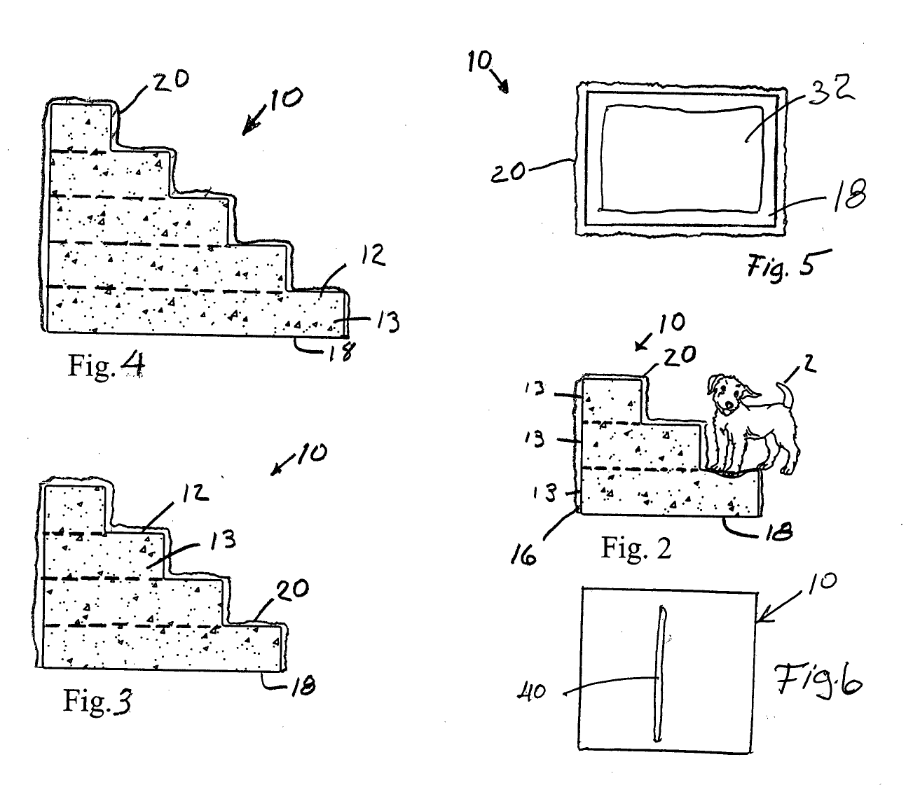

With reference to the drawings, FIGS. 1-8 depict the preferred embodiments of the instant invention which is generally referenced as a pet step device and, or by numeric character 10. With reference to FIGS. 1-5, the pet step device 10 comprises a plurality of elevated platforms or steps 12, sides 14, a backside 16, bottom side 18 and at least one removable cover 20. The instant invention 10 preferably offers a plurality of sizes for accessing various heights. The step device 10 preferably has three or more steps. For instance, with reference to FIG. 2, the pet step device 10 may have three steps 12 and a height of approximately thirteen inches, a width of approximately sixteen inches and a length of approximately eighteen inches. With reference to FIG. 3, the pet step device 10 may have four steps 12 and a height of approximately seventeen and a half inches, a width of approximately sixteen inches and a length of approximately twenty-four inches. With reference to FIG. 4, the pet step device 10 may have five steps 12 and a height of approximately twenty-two inches, a width of approximately sixteen inches and a length of approximately thirty inches. The pet step device 10 may also include six steps. Each step is preferably approximately six inches deep and four to five inches in height.

Regardless of the number of steps 12, each step 12 is individually fabricated and comprises an individual foam-based section 13. Adjoining sections 13 are stacked and bonded together with a commercially available adhesive or bonding technique for durability. The adhesive may comprise a pressure sensitive adhesive. By individually fabricating each step 12 and section 13 and stacking and bonding them together, the pet step device 10 maximizes support and facilitates substantially even or uniform weight distribution in the steps. In addition, employing individual sections 13 facilitates an efficient manufacturing process and conveniently accommodates the addition of more steps for larger designs. Each section 13 has the same width and height and differs in length.

The sections 13 are preferably fabricated from a high-density polyurethane foam having specifications that are substantially the same as or comparable to that sold under the trademark Flexible Foam by Flexible Foam Products, Inc. as follows. For instance, the foam section 13 may comprise urethane foam grade 100-36WH, 110-17CF and, or 190-95CH. The foam may have a density of 1.00±0.05 PCF (ASTM D-3574), I.F.D. of 36.0±3.0 lbs. at 25% and, or 65.0±5.0 lbs. at 65%, air flow of 3.0 CPM min., and support factor of 1.80 min. Alternatively, the foam may have a density of 1.10±0.5 PCF (ASTM D-3574), I.F.D. of 17.0±3.0 lbs. at 25% and, or 31.0±5.0 lbs. at 65%, air flow of 3.0 CPM min., and support factor of 1.80 min. The foam may also have a density of 1.90±0.1 PCF (ASTM D-3574), I.F.D. of 95.0±5.0 lbs. at 25% and, or 171.0±10 lbs. at 65%, air flow of 1.0 CPM min., and support factor of 1.80 min. The pet step device 10 preferably comprises 100% polyurethane foam and 100% polyester back.

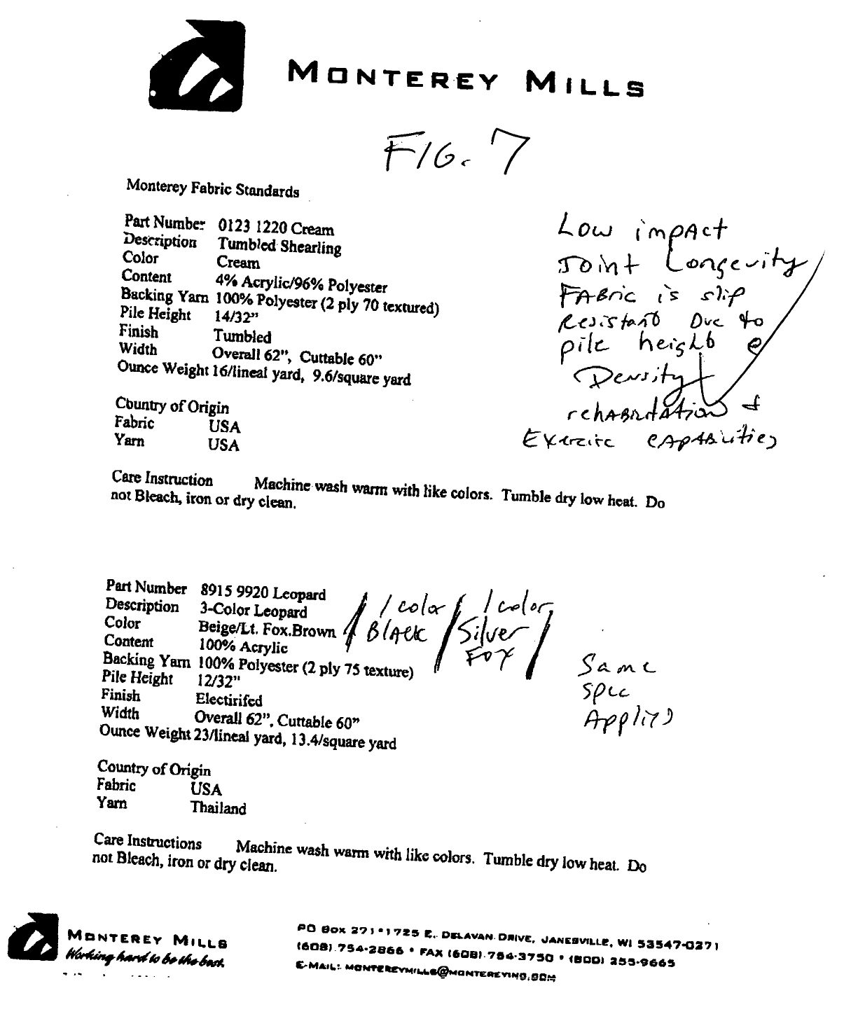

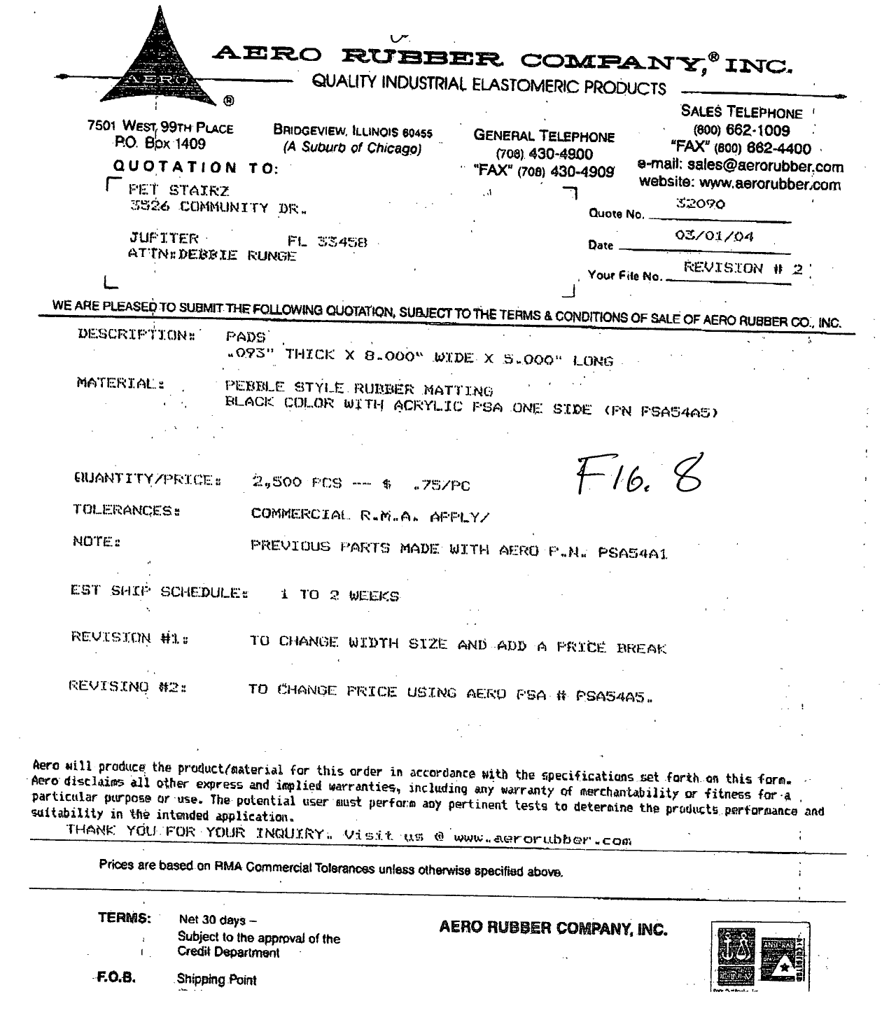

The pet step device 10 has at least one replaceable or interchangeable cover 20 and preferably a plurality of interchangeable covers 20 that offer different aesthetic designs. The cover 20 preferably has an elastic or stretchable open end that stretches over the foam sections 13 or steps 12, as shown in FIG. 5. The covers 20 preferably comprise a variety of interchangeable designs to accommodate personal tastes. The dimensions of the cover 20 are dictated by the size of the steps and overall step device 10. The cover 20 is preferably soft, provides sufficient traction and offers a low impact design to reduce stress on the joints in a manner that promotes joint longevity and pile-height at a predetermined density that facilitates slip resistance as well as exercising and rehabilitation capabilities. The preferred cover 20 meeting these requirements preferably comprises the specifications shown in FIG. 7 or comparable specifications. The cover 20 may comprise a size and shape that wraps under the bottom of the device 10 without enclosing the step device 10 completely and is secured with an elastic band, as shown in FIG. 5. In a second embodiment, the cover 20 may also comprise the requisite size and shape to completely enclose the step device 10. The second embodiment of the cover 20 includes an accessible opening with a fastener 40, as shown in FIG. 6, to facilitate securing, removing and installing the cover 20. The fastener 40 preferably comprises an industrial grade zipper or hook-and-loop (Velcro).

With reference to FIG. 1, a third embodiment of the cover 20 comprises a water resistant or repellant material, such as canvas or plastic based materials, which is more ideal for outdoor use. The third embodiment of the cover 20 includes an access opening and fastener 40, which preferably comprises a water-tight industrial grade zipper or hook-and-loop (Velcro). The third embodiment of the cover 20 preferably includes a rubber pad 32 on the bottom surface 18 of the step device 10 to prevent it from slipping to insure stability and rubber pads 30 on the steps 12 to prevent the animal from slipping while using the stairs. The rubber pads 30 on the steps should comprise the stress reducing properties as described herein. The rubber pads 30 and 32 preferably comprise the type and specifications as disclosed in FIG. 8.

In an alternative embodiment, the cover 20 may comprise a soft, washable fabric or fabric-based material. The material may comprise a curled micro yarn, such as that sold by the Textured Effects Group under style number 7534 in the 200 Series. The alternative specifications include a polyester fiber content and comprise 12.5 ounces per linear yard, 7.1 ounces per square yard and, or 242 grams per square meter. The surface characteristics may include a large curley peddle on the face and a small pebble on the back. The fabric is preferably washed in luke warm water (up to 40° C., 105° F.) and tumble dried at a low temperature. Fabric softeners and bleach should be avoided.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A pet step device for allowing pets to reach elevated locations, said device comprising:
a plurality of stacked sections, said sections comprising different lengths and stacked in a manner that forms a stepped design, side walls, back wall and bottom surface;
said sections comprising polyurethane foam;
adhesive for bonding said sections together;
removable cover that encloses at least said steps, side walls, back wall and a portion of the bottom proximal and around the edges;
means for securing said cover to said device.

2. A device as recited in claim 1, further comprising:
a rubber pad on a top surface of each step.

3. A device as recited in claim 1, further comprising:
a rubber pad on said bottom surface.

4. A device as recited in claim 1, wherein said cover comprises an access opening and fastener for opening and closing said access opening.

5. A device as recited in claim 1, wherein said cover completely encloses said device.

6. A device as recited in claim 1, wherein said cover comprises a low impact, pile-height fabric that absorbs impact forces and reduces stress on the pets body.

7. A device as recited in claim 1, wherein said cover comprises a water-repellant material.

8. A device as recited in claim 4, wherein said fastener comprises a zipper.

9. A device as recited in claim 4, wherein said fastener comprises hook-and-loop.
